(19) United States
(12) Patent Application Publication
(10) Pub. No.: US 2013/0321439 A1
(43) Pub. Date: Dec. 5, 2013

(54) METHOD AND APPARATUS FOR ACCESSING VIDEO DATA FOR EFFICIENT DATA TRANSFER AND MEMORY CACHE PERFORMANCE

(71) Applicant: Allen B. Goodrich, Reut (IL)

(72) Inventor: Allen B. Goodrich, Reut (IL)

(21) Appl. No.: 13/485,089

(22) Filed: May 31, 2012

(51) Int. Cl. G09G 5/36

(52) U.S. Cl. 345/547

(57) ABSTRACT

An apparatus comprising a plurality of memory modules and a plurality of memory controllers. The plurality of memory modules may be configured to store video data in a half-macroblock organization. Each of the plurality of memory controllers is generally associated with one of the memory modules. The memory controllers are generally configured to index a fetch of pixel data for an unaligned macroblock from the plurality of memory modules.

### FIELD OF THE INVENTION

The present invention relates to video data storage generally and, more particularly, to a method and/or apparatus for accessing video data for efficient data transfer and cache performance.

### BACKGROUND OF THE INVENTION

Video data is often organized as a set of sub-arrays (or blocks), each 16 by 16 pixels, instead of a single array of pixels the size of the total frame. Each pixel uses one byte of memory. The organization using these sub-arrays, usually called macroblocks, aids in the localization of data for performing functions such as motion estimation. A typical motion estimation process involves each 16 by 16 array of pixels of a current frame being compared to another 16 by 16 array in another (reference) frame. For the typical motion estimation process, the 16 by 16 arrays are not aligned to the 16 by 16 macroblock boundaries. In general, a non-aligned 16 by 16 array can be composed of parts of four macroblocks. The parts of the four macroblocks each need to be accessed, each with a penalty depending on the physical implementation of the data storage medium, either cache or memory. Both caches and memories, like dynamic random access memories (DRAMs), are organized in long rows. Minimizing the number of rows to be accessed translates to improving the performance of the system.

It would be desirable to implement a method and/or apparatus for accessing video data for efficient data transfer and cache performance.

### SUMMARY OF THE INVENTION

The present invention concerns an apparatus comprising a plurality of memory modules and a plurality of memory controllers. The plurality of memory modules may be configured to store video data in a half-macroblock organization. Each of the plurality of memory controllers is generally associated with one of the memory modules. The memory controllers are generally configured to index a fetch of pixel data for an unaligned macroblock from the plurality of memory modules.

The objects, features and advantages of the present invention include providing a method and/or apparatus for accessing video data for efficient data transfer and cache performance that may (i) reduce the amount of time to access a 16×16 array of non-aligned image data, (ii) organize video data using half macroblocks, (iii) implement a memory comprising sixteen modules, each 64 bits wide, (iv) implement a 512 bit data bus, (v) send saved extra first fetched bits at the same time as second fetched bits to a processor, (vi) re-align an unaligned macroblock prior to processing, and/or (vii) fetch an unaligned macroblock in a maximum of four 512-bit transfers.

### BRIEF DESCRIPTION OF THE DRAWINGS

These and other objects, features and advantages of the present invention will be apparent from the following detailed description and the appended claims and drawings in which:

FIG. 1 is a block diagram illustrating a portion of a computer system in which an embodiment of the present invention may be implemented;

FIG. 2 is a diagram illustrating a plurality of memory modules arranged in accordance with an embodiment of the present invention;

FIG. 3 is a diagram illustrating an example four cycle memory module in accordance with an embodiment of the present invention;

FIG. 4 is a diagram illustrating an example two cycle memory module in accordance with another embodiment of the present invention;

FIGS. 5 and 6 are diagrams illustrating an example data organization in accordance with an embodiment of the present invention;

FIGS. 7 and 8 are diagrams illustrating two cases for an unaligned macroblock in a half-macroblock organized memory system in accordance with an embodiment of the present invention;

FIG. 9 is a diagram illustrating an example indexing and segmentation scheme in accordance with an embodiment of the present invention;

FIG. 10 is a diagram illustrating an example data transfer for an unaligned macroblock with a start address in an even half-macroblock;

FIG. 11 is a diagram illustrating an example data transfer for an unaligned macroblock with a start address in an odd half-macroblock; and

FIG. 12 is a flow diagram illustrating an example process in accordance with an embodiment of the present invention.

### DETAILED DESCRIPTION OF THE PREFERRED EMBODIMENTS

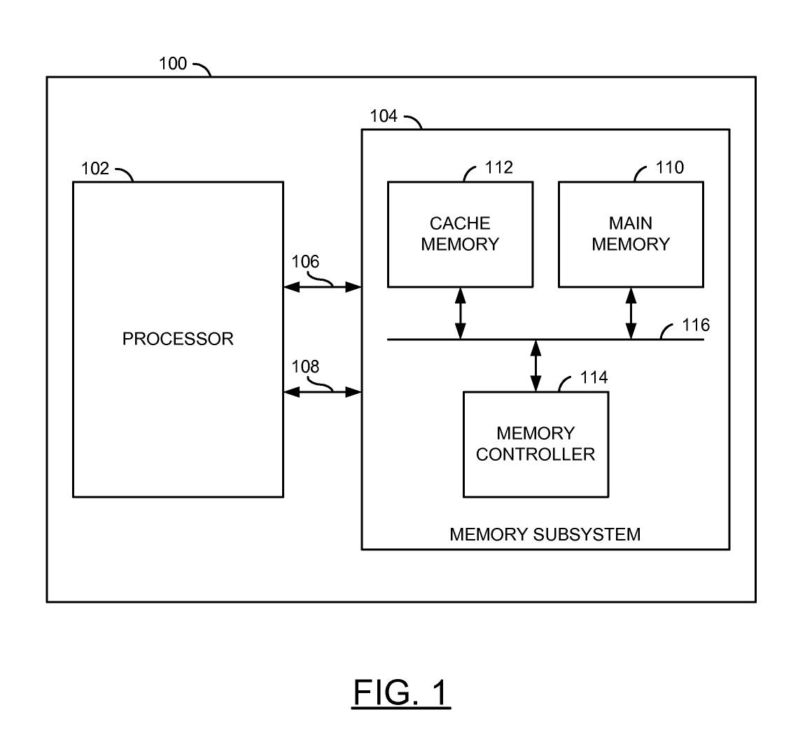

Referring to FIG. 1, a block diagram of a system 100 is shown illustrating a portion of a computer system in which an embodiment of the present invention may be implemented. The system 100 generally includes a block 102 and a block 104. The block 102 may implement a processor. The block 102 may be implemented using any conventional or later-developed type or architecture of processor. In one example, the block 102 may comprise a digital signal processor (DSP) core configured to implement one or more video codecs. The block 104 may implement a memory subsystem. In one example, a bus 106 may couple the block 102 and the block 104. In another example, an optional second bus 108 may also be implemented coupling the block 102 and the block 104. The bus 106 and the bus 108 may be implemented, in one example, as 512 bits wide busses.

In one example, the block 104 may comprise a block 110, a block 112, and a block 114. The block 110 may implement a main memory of the system 100. The block 112 may implement a cache memory of the system 100. The block 114 may implement a memory controller. The blocks 110, 112, and 114 may be connected together by one or more (e.g., data, address, control, etc.) busses 116. The blocks 110, 112, and 114 may also be connected to the busses 106 and 108 via the busses 116. The block 110 may be implemented having any size or speed or of any conventional or later-developed type of memory. In one example, the block 110 may itself be a cache memory for a still-larger memory, including, but not limited to nonvolatile (e.g., static random access memory (SRAM), FLASH, hard disk, optical disc, etc.) storage. The block 110 may also assume any physical configuration. In general, irrespective of how the block 110 may be physically configured, the block 110 logically represents one or more addressable memory spaces.

The block 112 may be of any size or speed or of any conventional or later-developed type of cache memory. The block 114 may be configured to control the block 110 and the block 112. For example, the block 114 may copy or move data from the block 110 to the block 112 and vis versa, or maintain the memories in the blocks 110 and 112 through, for example, periodic refresh or backup to nonvolatile storage (not shown). The block 114 may be configured to respond to requests, issued by the block 102, to read or write data from or to the block 110. In responding to the requests, the block 114 may fulfill at least some of the requests by reading or writing data from or to the block 112 instead of the block 110.

The block 114 may establish various associations between the block 110 and the block 112. For example, the block 114 may establish the block 112 as set associative with the block 110. The set association may be of any number of “ways” (e.g., 2-way or 4-way), depending upon, for example, the desired performance of the memory subsystem 104 or the relative sizes of the block 112 and the block 110. Alternatively, the block 114 may render the block 112 as being fully associative with the block 110, in which case only one way exists. Those skilled in the pertinent art would understand set and full association of cache and main memories. The architecture of properly designed memory systems, including stratified memory systems, and the manner in which cache memories may be associated with the main memories, are transparent to the system processor and computer programs that execute thereon. Those skilled in the relevant art(s) would be aware of the various schemes that exist for associating cache and main memories and, therefore, those schemes need not be described herein.

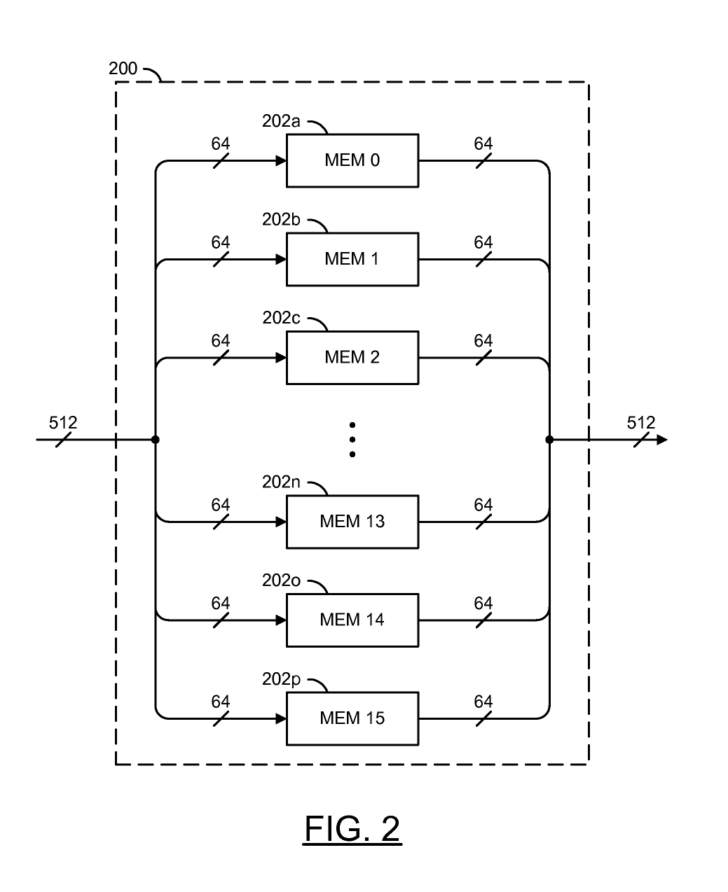

Referring to FIG. 2, a diagram is shown illustrating a memory architecture 200 in accordance with an embodiment of the present invention. In one example, the memory architecture 200 may comprise sixteen memory modules 202a-202p. Each having the memory modules 202a-202p may be implemented with 64-bit wide data busses. The 64-bit wide busses of the memory modules 202a-202p may be connected to form a pair of 512-bit wide busses. The memory architecture 200 may be used to implement one or more of the memories 110 and 112 of FIG. 1. The 512-bit wide busses of the memory architecture 200 may be configured to connect the memory modules 202a-202p to one or both of the busses 106 and 108 of FIG. 1.

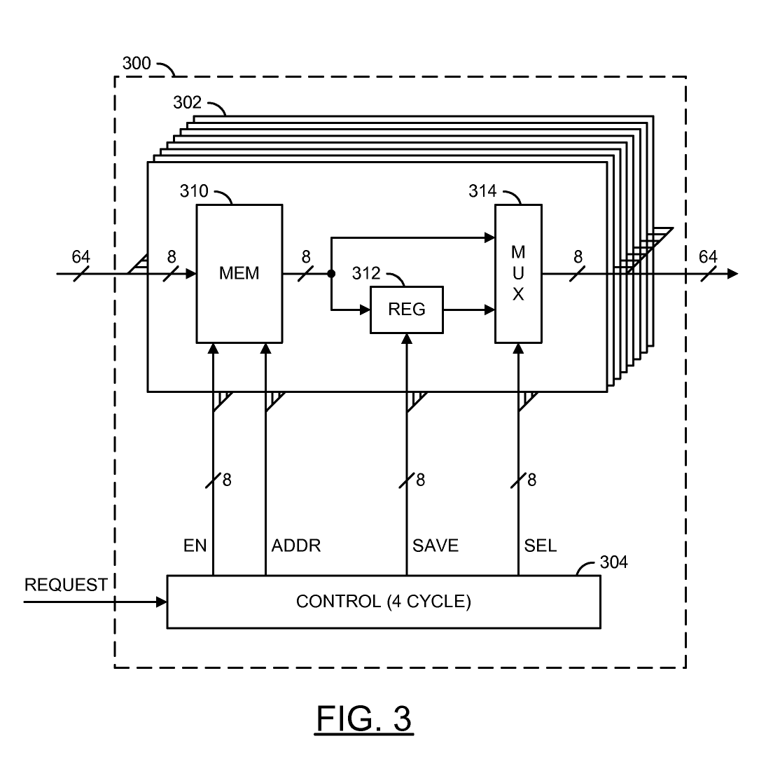

Referring to FIG. 3, a diagram is shown illustrating an example four cycle memory module 300 in accordance with an embodiment of the present invention. In one example, the four cycle memory module 300 may be used to implement the memory modules 202a-202p in FIG. 2. The memory module 300 may comprise a 64-bit internal memory module. The memory module 300 may have a 64-bit wide input bus, a 64-bit wide output bus and an input that may receive a signal (e.g., REQUEST). The signal REQUEST may specify an address to be read or written. In one example the address contained in the signal REQUEST may specify an upper right hand corner of an unaligned macroblock to be fetched from the memory module 300.

The memory module 300 may comprise a 64-bit wide memory array 302 and a control circuit 304. The control circuit 304 may be configured to generate a first signal (e.g., EN), a second signal (e.g., ADDR), a third signal (e.g., SAVE), and a fourth signal (e.g., SEL) in response to the signal REQUEST. In one example, the signals EN, SAVE, and SEL may implement 8-bit wide control signals. The signal ADDR may implement an address signal. The 64-bit wide memory array 302 may comprise a number of memory planes. In one example, the number of planes may be eight. Each of the planes in the memory array 302 may be implemented with 8-bit wide input and output busses. The 8-bit wide input and output busses of the memory planes are generally arranged to form the 64-bit wide input and output busses of the memory array 302. Each memory plane of the memory array 302 may receive the signal ADDR and a respective bit of the 8-bit wide signals EN, SAVE, and SEL.

In one example, each memory plane may comprise a block (or circuit) 310, a block (or circuit) 312, and a block (or circuit) 314. The block 310 may implement an 8-bit wide memory. The block 312 may implement a register block. The block 314 may implemented a multiplexer. An input of the block 310 may be connected to the input bus of the memory module 300. An output of the block 310 may connect to a first input of the block 312 and a first input of the block 314. An output of the block 312 may be connected to a second input of the block 314. The block 310 may have a second input that may receive the respective bit of the signal EN and a third input that may receive the signal ADDR. The block 312 may have a control input that may receive the respective bit of the signal SAVE. The block 314 may have a control input that may receive the respective bit of the signal SEL. The signal EN and ADDR generally determine which location in the block 310 are accessed and the type of access. The signal SAVE generally determines whether accessed data is saved in the block 312. The signal SEL generally determines whether each bit passed to the output bus of the memory module 300 is from the block 310 or the block 312. The block 304 is generally configured to implement an indexing scheme in accordance with an embodiment of the present invention by generating the signals EN, ADDR, SAVE, and SEL in response to the signal REQUEST.

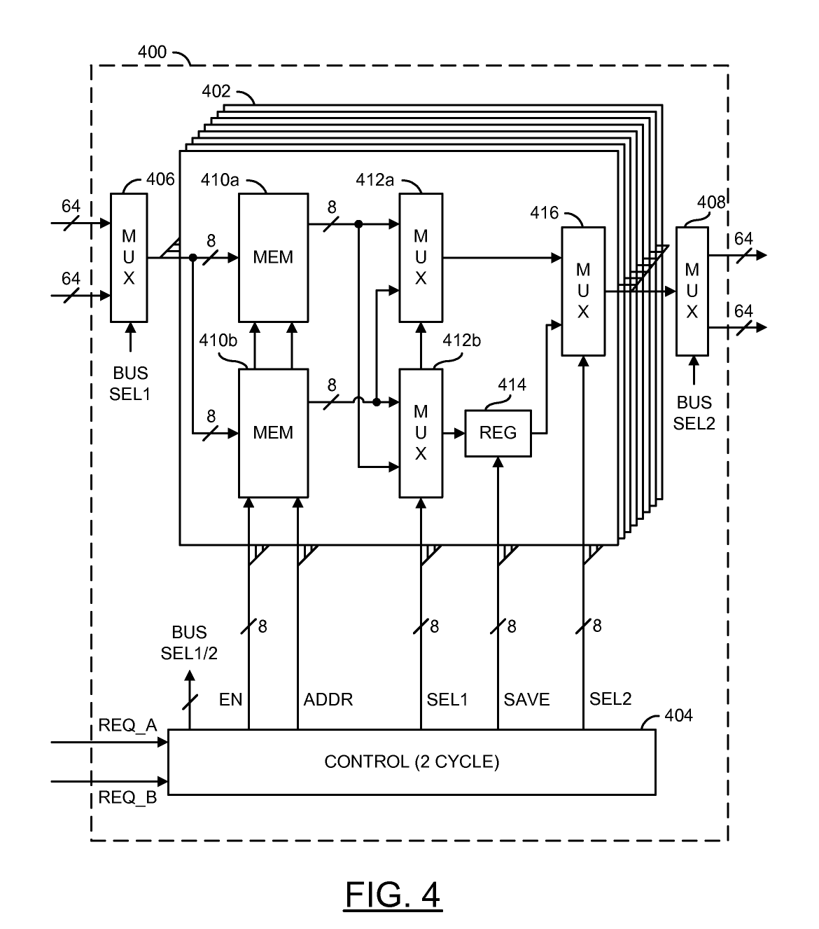

Referring to FIG. 4, a diagram is shown illustrating an example memory module 400 in accordance with another embodiment of the present invention. In one example, the two cycle memory module 400 may be used to implement the memory modules 202a-202p in FIG. 2. The memory module 400 may comprise a 128-bit internal memory module. The memory module 400 may have two 64-bit wide input busses, two 64-bit wide output busses, a first input that may receive a signal (e.g., REQ_A), and a second input that may receive a signal (e.g., REQ_B). The signals REQ_A and REQ_B may specify addresses to be read or written. In one example the addresses contained in the signals REQ_A and REQ_B may specify upper right-hand corners of unaligned macroblocks to be fetched from the memory module 400.

The memory module 400 may comprise a 128-bit wide memory array 402, a control circuit 404, an input bus selector 406, and an output bus selector 408. The control circuit 404 may be configured to generate a first signal (e.g., EN), a second signal (e.g., ADDR), a third signal (e.g., SEL1), a fourth signal (e.g., SAVE), a fifth signal (e.g., SEL2), and a sixth signal or signals (e.g., BUS SEL 1/2) in response to the signals REQ_A and REQ_B. In one example, the signals EN, SEL1, SAVE, and SEL2 may implement 8-bit wide control signals. The signal ADDR may implement an address signal. In one example, the signal BUS SEL 1/2 may be implemented as a multi-bit control signal, where individual bits may be used as control signals (e.g., BUS SEL1 and BUS SEL2) to control the selectors 406 and 408. In another example, the signal BUS SEL 1/2 may be implemented as multiple control signals comprising the signals BUS SEL1 and BUS SEL2. The 128-bit wide memory array 402 may comprise a number of memory planes. In one example, the number of planes may be eight. Each of the planes in the memory array 402 may be implemented with 8-bit wide input and output busses. The 8-bit wide input and output busses of the memory planes are generally arranged to form the 64-bit wide input and output busses of the memory array 402. Each memory plane of the memory array 402 may be configured as two 8-bit memories connected in parallel. Each memory plane of the memory array 402 may receive the signal ADDR and a respective bit of the 8-bit wide signals EN, SEL1, SAVE, and SEL2. The selectors 406 and 408 may be configured to connect the 64-bit wide input and output busses of the memory array 402 to the appropriate 64-bit system busses in response to the signals BUS SEL1 and BUS SEL2 generated by the control circuit 404.

In one example, each memory plane may comprise a block (or circuit) 410a, a block (or circuit) 410b, a block (or circuit) 412a, a block (or circuit) 412b, a block (or circuit) 414, and a block (or circuit) 416. The blocks 410a and 410b may implement 8-bit wide memories. The blocks 412a and 412b may implement multiplexers. The block 414 may implement a register block. The block 416 may implemented a multiplexer. An input of the blocks 410a and 410b may be connected to the input bus of the memory module 400. An output of the block 410a may be connect to a first input of the block 412a and a first input of the block 412b. An output of the block 410b may be connect to a second input of the block 412a and a second input of the block 412b. The blocks 412a and 412b have a control input that may receive the respective bit of the signal SEL1. The blocks 410a, 410b, 412a, and 412b are generally connected such that the blocks 412a and 412b select the output from different ones of the blocks 410a and 410b for a particular value of the respective bit of the signal SEL1.

An output of the block 412a may be connected to a first input of the block 416. An output of the block 412b may be connected to an input of the block 414. An output of the block 414 may be connected to a second input of the block 416. The blocks 410a and 410b may have a second input that may receive the respective bit of the signal EN and a third input that may receive the signal ADDR. The block 414 may have a control input that may receive the respective bit of the signal SAVE. The block 416 may have a control input that may receive the respective bit of the signal SEL2. The signal EN and ADDR generally determine which location in the blocks 410a and 410b are accessed and the type of access. The signal SAVE generally determines whether accessed data is saved in the block 414. The signal SEL1 generally determine whether each bit from the blocks 410a and 410b are passed to the output bus of the memory module 400 or saved in the block 414. The signal SEL2 generally determines whether each bit passed to the output bus of the memory module 400 is from one of the blocks 410a and 410b or the block 414. The block 404 is generally configured to implement an indexing scheme in accordance with an embodiment of the present invention by generating the signals EN, ADDR, SEL1, SAVE, and SEL2 in response to the signals REQ_A and REQ_B.

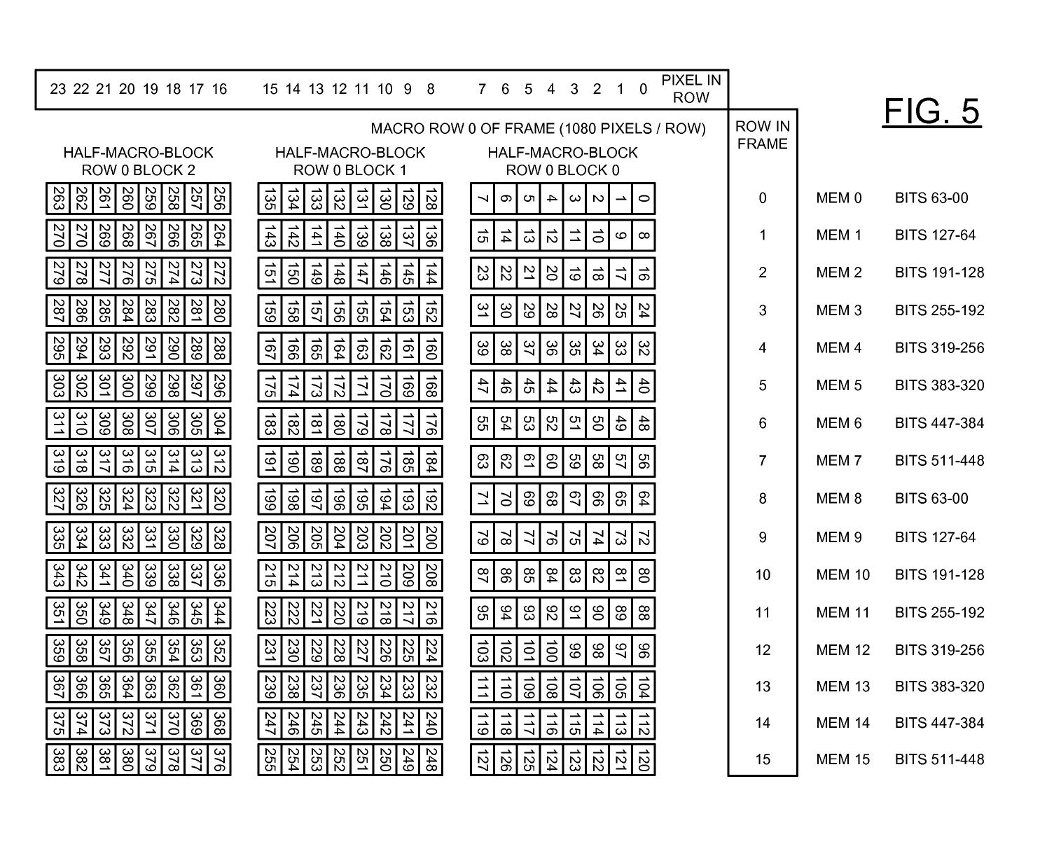

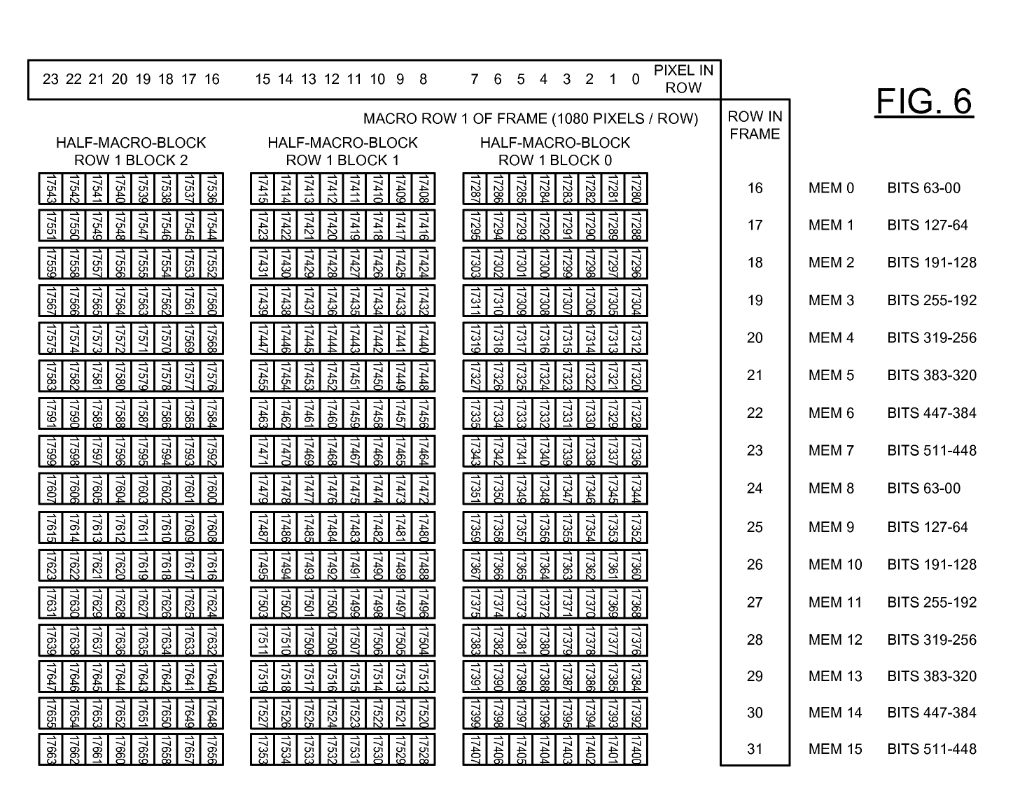

Referring to FIGS. 5 and 6, diagrams are shown illustrating a first macroblock row (FIG. 5) and a second macroblock row (FIG. 6) of an image stored with a half-macroblock organization in accordance with an embodiment of the present invention. In one example, an image may be arranged in a half-macroblock organization and indexed such that pixels having the same relative position in two adjacent half-macroblocks are designated by (i) respective column indices that differ by a value of 128 and (ii) respective row indices that differ by a value equal to sixteen times a row length of the image. For example, in an image with 1080 pixels per row, the upper right-hand pixel of half-macroblock row 0, block 0 may be designated as pixel 0, the upper right-hand pixel of half-macroblock row 0, block 1 may be designated as pixel 128, the upper right-hand pixel of half-macroblock row 0, block 2 may be designated as pixel 256, . . . , the upper right-hand pixel of half-macroblock row 1, block 0 may be designated as pixel 17280, etc. The indexing scheme in accordance with embodiments of the present invention generally allow pixels having the same relative position in two adjacent half-macroblocks to be addressed by complementing one or more bits of the respective pixel addresses. As would be apparent to those skilled in the relevant art(s), the indexing may be scaled accordingly to meet the design criteria of a particular implementation. For example, example designations for the upper right-hand pixel of half-macroblock row 1, block 0 relative to the row length for a variety of video standards may be summarized as in the following TABLE 1:

TABLE 1

| Video | Pixels | Starting index of |
|---|---|---|
| Standard | per row | second macroblock row |
| VGA, SDTV 480i | 640 | 10240 |
| DVD | 720 | 11520 |
| WVGA, SDTV 576i | 768 | 12288 |
| SVGA | 800 | 12800 |
| WSVGA | 1024 | 16384 |
| 720p | 1280 | 20480 |
| 1080i | 1440 | 23040 |
| UXGA | 1600 | 25600 |
| HD, FHD | 1920 | 30720 |
| 2K | 2048 | 32768 |
| 4K | 4096 | 65536 |
| WHUXGA, 4320p | 7680 | 122880 |
| 8K | 8192 | 131072 |

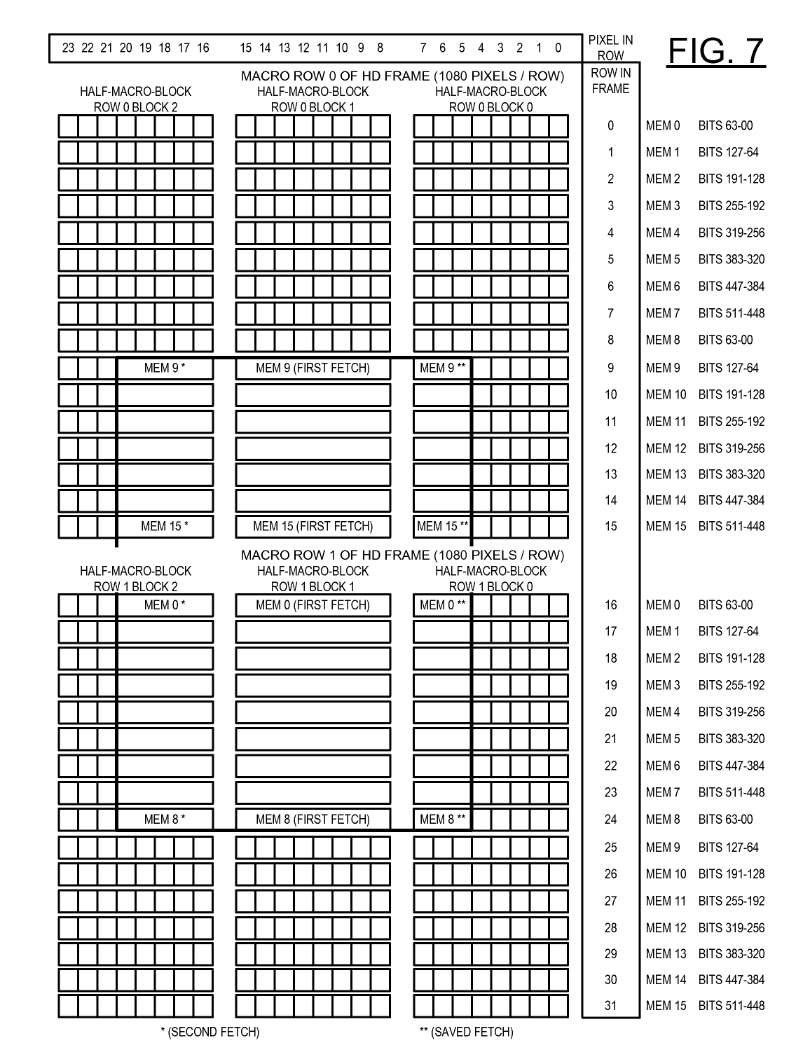

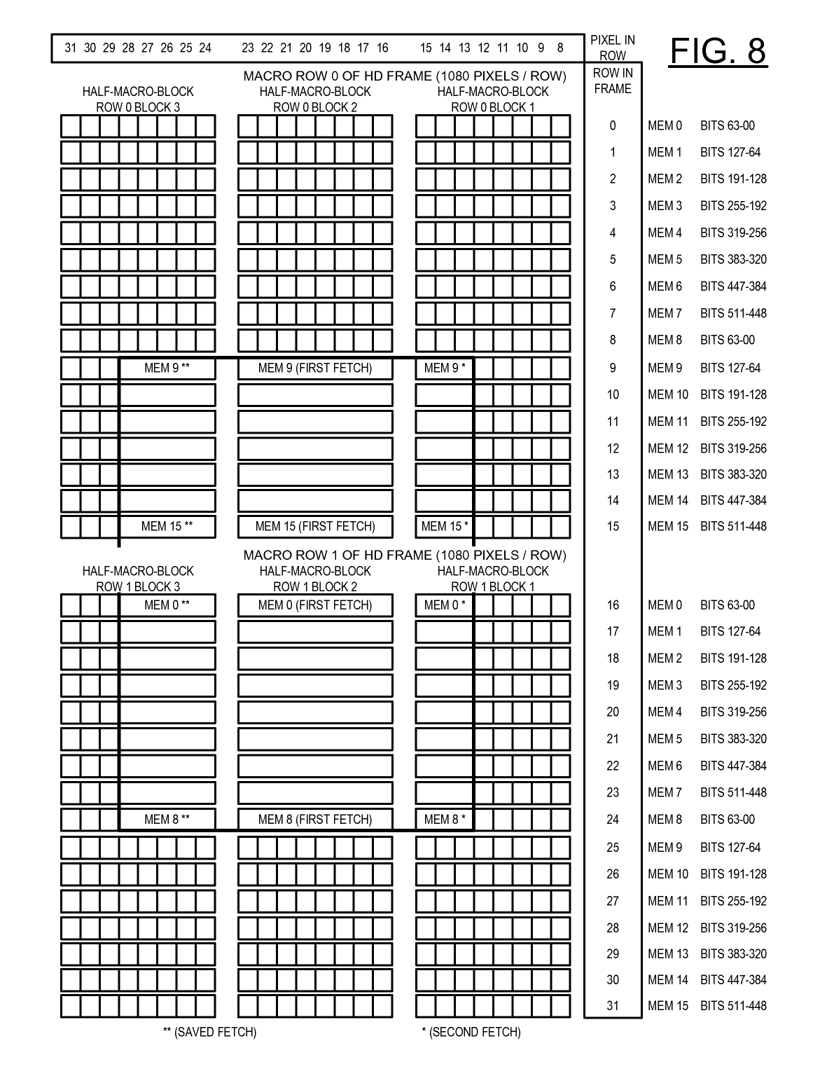

Referring to FIGS. 7 and 8, diagrams are shown illustrating an example unaligned macroblock starting in an even half-macroblock (FIG. 7) and starting in an odd half-macroblock (FIG. 8). The order in which the pixels of an unaligned macroblock are accessed and placed on the bus (or busses) by a memory implemented in accordance with an embodiment of the present invention generally depends upon whether the upper right-hand pixel of the unaligned macroblock being accessed is in an even half-macroblock or an odd half-macroblock. In general, bits belonging to the same stored macroblock are accessed during the same access cycle with those bits that exceed the bus capacity being stored for the next access cycle.

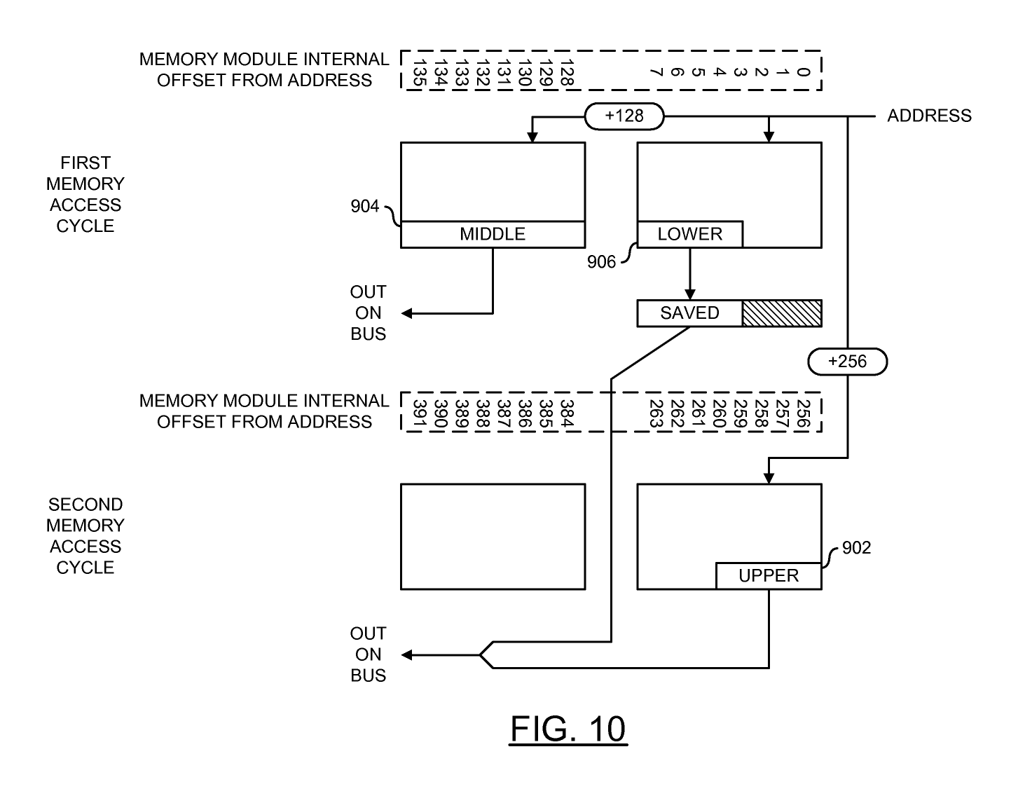

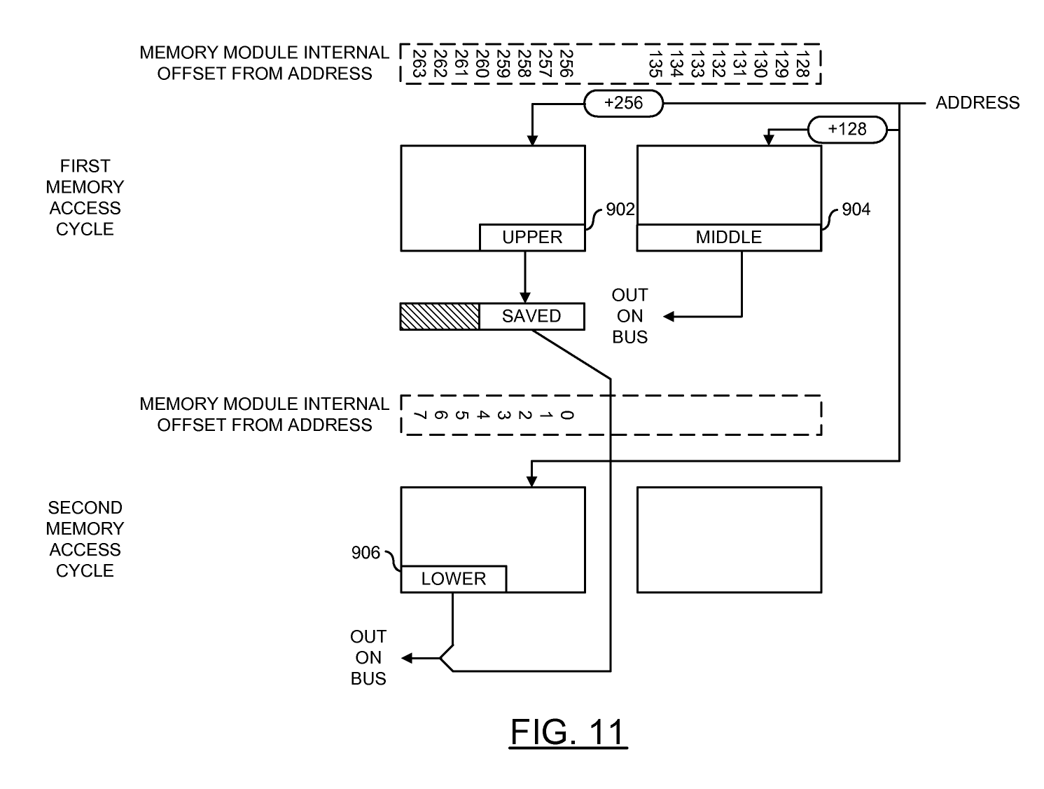

With a combination of data organization of the images in memory and access hardware in accordance with an embodiment of the present invention, the amount of time taken to access a 16 by 16 array of non-aligned image data may be reduced. By using a half-macroblock organization instead of full macroblocks, the indexing in accordance with an embodiment of the present invention to fetch all 256 bytes of any unaligned macroblock may be accomplished as illustrated below in connection with FIGS. 10 and 11.

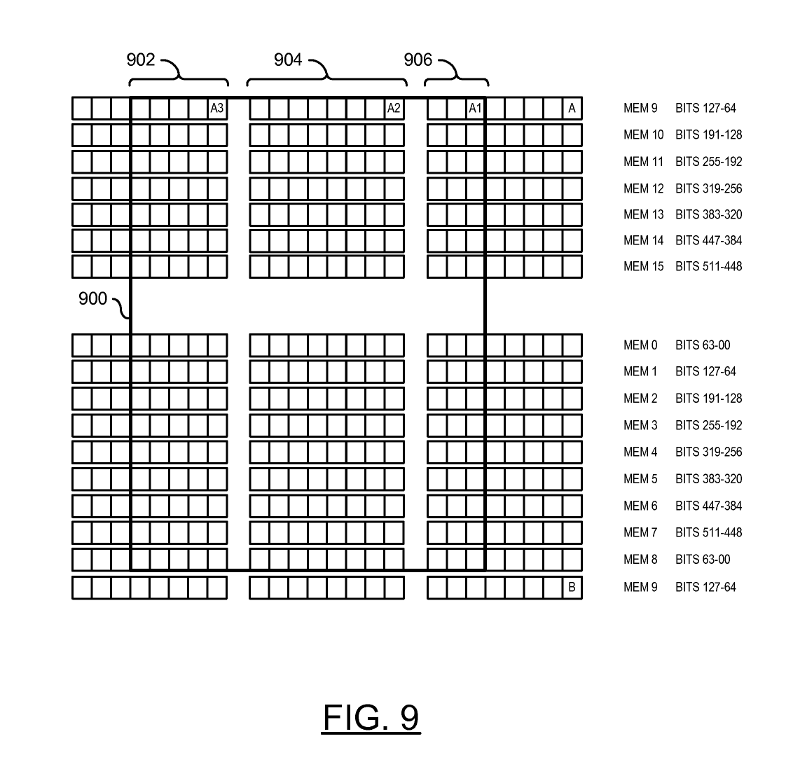

Referring to FIG. 9, a diagram is shown illustrating an example unaligned macroblock 900 as an overlay on pixels stored in a half-macroblock organization in accordance with an embodiment of the present invention. In one example, the unaligned macroblock 900 may comprise a upper portion 902, a middle portion 904 and a lower portion 906. In one example, the unaligned macroblock 900 may be identified in access requests using the address of the upper right-hand corner pixel (e.g., A1). The address of the first pixel in the same row and half-macroblock as the pixel A1 may be identified as having address A. The difference between the addresses A1 and A is generally referred to as the unalignment offset, or offset for short. Once the address A is determined, the three portions of the unaligned macroblock 900 may be addressed based upon the address A. For example, the lower portion 906 begins at A1 (e.g., A1=A+OFFSET). The starting address (e.g., A2) of the middle portion may be determined by adding 128 to the address A (e.g., A2=A+128). The starting address (e.g., A3) of the upper portion may be determined by adding 256 to the address A (e.g., A3=A+256). The starting address (e.g., B) of the next unaligned macroblock below the unaligned macroblock 900 may be determined by adding a value that is sixteen times the row length to the address A (e.g., B=A (ROW LENGTH)*16). The memory modules in accordance with embodiments of the present invention are generally configured to determine the offset value for each unaligned macroblock requested.

Referring to FIG. 10, a diagram is shown illustrating an example data transfer for an unaligned macroblock 900 with a start address in an even half-macroblock. In one example, the middle portion 904 of the unaligned macroblock 900 may be fetched first followed by a remaining portion (e.g., merged upper and lower portions) of the macroblock. By fetching the middle portion 904 of the unaligned macroblock 900 first, an entire macroblock may be fetched in four cycles using a single 512 bits wide data bus. The fetch may be accomplished in four cycles using one 512-bit bus. In one example, the fetch may be accomplished in two cycles when two 512-bit busses are implemented. When two 512-bit busses are implemented, the memory modules 202a-202n generally do not all receive the same address. Instead, indexes may be computed with offsets to match the row length of the total image (e.g., for an image with 1080 pixels per row the index between macroblock row 0 and macroblock row 1 is 17280).

When the unaligned macroblock 900 starts in an even half-macroblock, the memory may fetch the lower portion 906 at the same time the middle portion 904 of the unaligned macroblock 900 is fetched. The lower portion 906 is saved to be sent as part of a second transfer. For the second fetch, the indices for the memory modules are adjusted (e.g., incremented in this example, decremented in others) and the second fetch is performed. In the case where the unaligned macroblock 900 starts in an even half-macroblock, the second fetch comprises the upper portion 902. The saved first fetch bits (e.g., the lower portion 906) and the second fetched bits (e.g., the upper portion 902) may be merged and sent at the same time to the processor since the bits do not conflict on the bus to the master. Two more 512 bit transfers or one more clock using two buses may complete the fetch of the entire unaligned macroblock (as illustrated by the bus bits associated with each memory module in FIG. 9). Thus, using a half-macroblock memory organization and indexing implemented in accordance with an embodiment of the present invention, a fetch of an entire unaligned macroblock may be performed in a guaranteed four 512-bit transfers.

Referring to FIG. 11, a diagram is shown illustrating an example data transfer for an unaligned macroblock with a start address in an odd half-macroblock. In one example, the middle portion 904 of the unaligned macroblock 900 is again fetched first followed by the remaining portion (e.g., merged upper and lower portions) of the macroblock. When the unaligned macroblock 900 starts in an odd half-macroblock, the memory may fetch the upper portion 902 of the unaligned macroblock 900 at the same time the middle portion 904 of the unaligned macroblock 900 is fetched. The upper portion 902 is saved to be part of the second transfer. For the second fetch, the indices for the memory modules are adjusted (e.g., incremented in this example, decremented in others) and the second fetch is performed. In the case where the unaligned macroblock 900 starts in an odd half-macroblock, the second fetch comprises the lower portion 906 of the unaligned macroblock 900. The saved first fetch bits (e.g., from the upper portion 902) and the second fetched bits (e.g., from the lower portion 906) may be merged and sent at the same time to the processor since the bits do not conflict on the bus to the master. Two more 512 bit transfers or one more clock using two buses may complete the fetch of the entire unaligned macroblock (as illustrated by the bus bits associated with each memory module in FIG. 9).

In general, the middle portion 904 of the unaligned macroblock 900 may be fetched first followed by a remaining portion (e.g., merged upper and lower portions) of the macroblock. By fetching the middle portion 904 of the unaligned macroblock 900 first, an entire macroblock may be fetched in four cycles using a single 512 bits wide data bus. In one example, the fetch may be accomplished in two cycles when two 512-bit busses are implemented. When two 512-bit busses are implemented, the memory modules 202a-202n generally do not all receive the same address. Instead, indexes may be computed with offsets to match the row length of the total image (e.g., for an image with 1080 pixels per row the index between macroblock row 0 and macroblock row 1 is 17280).

At the same time the middle portion 904 of the unaligned macroblock 900 is fetched, the memory may fetch a “saved first fetch” part of a second transfer. The “saved first fetch” part depends on the half-macroblock in which the unaligned macroblock starts. For the second fetch, the indices for the memory modules are adjusted (e.g., incremented in this example, decremented in others) and the second fetch is performed. The saved first fetch bits and the second fetched bits may be merged and sent at the same time to the processor since the bits do not conflict on the bus to the master. Two more 512 bit transfers or one more clock using two buses may complete the fetch of the entire unaligned macroblock. Thus, using a half-macroblock memory organization and indexing implemented in accordance with an embodiment of the present invention, a fetch of an entire unaligned macroblock may be performed in a guaranteed four 512-bit transfers.

In general, although the second fetch may involve incrementing or decrementing the address, the first transfer generally provides the cycle(s) to hide/perform the incrementing or decrementing calculation. Each memory module 202a-202n may include logic that is the same except for some offsets. Thus, the system 100 generally provides a modular implementation that is very desirable.

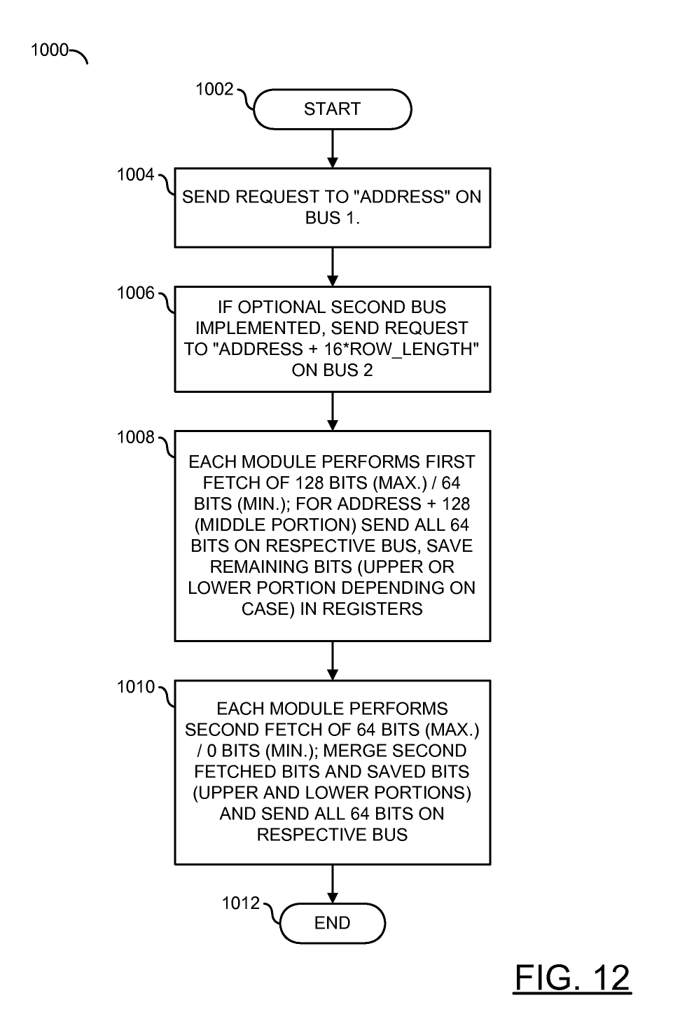

Referring to FIG. 12, a flow diagram is shown illustrating a process 1000 in accordance with an embodiment of the present invention. The process (or method) 1000 may comprise a start step (or state) 1002, a step (or state) 1004, a step (or state) 1006, a step (or state) 1008, a step (or state) 1010, and an end step (or state) 1012. The step 1006 may be omitted. The process 1000 begins in the start step 1002. In the step 1004, the process 1000 sends a request to an address (e.g., ADDRESS) on a first bus (e.g., BUS 106 in FIG. 1). In the step 1006, the process 1000 sends a request to a second address. The second address may point to a next macroblock row below the macroblock row associated with ADDRESS (e.g., second address=ADDRESS+(Row length)*16) on a second bus (e.g., BUS 108 in FIG. 1). In the step 1008, the process 1000 generally performs a first fetch in each memory module. The first fetch is generally 128 bits maximum and 64 bits minimum. When the memory modules are implemented as four cycle modules (e.g., the module 300 of FIG. 3), the 128 bit fetch is performed over two cycles. The process 1000 generally sends 64 bits from the same half-macroblock first and saves the remaining bits of the first fetch. In the step 1010, the process 1000 performs a second fetch in each memory module. The second fetch is generally 64 bits maximum and 0 bits minimum. The process 1000 transfers the saved bits along with the bits of the second fetch on the respective bus. The process 1000 generally ends in the end step 1012.

Although examples have been presented herein using particular numbers of bits, it will be apparent to those of ordinary skill in the relevant art(s), based on the examples and material presented herein, that the various sizes and relationships (e.g., bits per pixel, bus sizes, planes per memory module, assignment of bus bits to memory modules, memory widths, etc.) may be varied or scaled to meet the design criteria of a particular implementation. The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The functions performed in the diagrams of FIGS. 10-12 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a plurality of memory modules configured to store video data in a half-macroblock organization; and
a plurality of memory controllers, each of said plurality of memory controllers associated with one of said memory modules, wherein said memory controllers are configured to index a fetch of pixel data for an unaligned macroblock from the plurality of memory modules.

2. The apparatus according to claim 1, wherein said plurality of memory modules comprises sixteen memories, each 64 bits wide.

3. The apparatus according to claim 1, wherein said plurality of memory modules comprises sixteen memories, each 128 bits wide internally.

4. The apparatus according to claim 1, further comprising:
a processor; and
a data bus connecting said processor to said plurality of memory modules, wherein said data bus is 512 bits wide.

5. The apparatus according to claim 4, wherein a fetch of an entire unaligned macroblock is performed in four 512-bit transfers.

6. The apparatus according to claim 4, further comprising:
a second data bus connecting said processor to said plurality of memory modules, wherein said second data bus is 512 bits wide.

7. The apparatus according to claim 1, wherein each of said plurality of memory controllers implements a logic block and said logic block is the same for each of said memory modules except for one or more offsets.

8. A method of accessing video data comprising the steps of:
storing said video data in a plurality of memory modules using a half-macroblock organization;
fetching a middle portion of an unaligned macroblock and a first fetch part of a second fetch portion of an unaligned macroblock from said plurality of memory modules; and
fetching said second fetch portion of the unaligned macroblock from the plurality of memory modules, wherein the unaligned macroblock is transferred to a processor in four cycles using a single 512 bits wide data bus.

9. The method according to claim 8, further comprising:
computing indices for accessing said plurality of memory modules based upon a row length of an image being processed.

10. The method according to claim 9, further comprising:
adjusting the indices between said first and said second fetch.

11. The method according to claim 10, further comprising:
incrementing or decrementing the indices between said first and said second fetch based upon the row length of the image being processed.

12. A method of accessing video data comprising the steps of:
storing said video data in a plurality of memory modules using a half-macroblock organization;
fetching a middle portion and a first fetch part of a second fetch portion of an unaligned macroblock from said plurality of memory modules;
fetching said second fetch portion of the unaligned macroblock from the plurality of memory modules; and
transferring the unaligned macroblock to a processor in two cycles using two 512 bit wide data bus.

13. The method according to claim 12, further comprising:
computing indices for accessing said plurality of memory modules based upon a row length of an image being processed.

14. The method according to claim 13, further comprising:
adjusting the indices between said first and said second fetch.

15. The method according to claim 13, further comprising:
incrementing or decrementing the indices between said first and said second fetch based upon the row length of the image being processed.
